(19) United States
(12) Patent Application Publication
(10) Pub. No.: US 2016/0273192 A1
(43) Pub. Date: Sep. 22, 2016

(54) Hydraulic Pressure Circuit and Working Machine

(71) Applicant: CATERPILLAR SARL, Geneva (CH)

(72) Inventors: Shigeo Kajita, Tokyo (JP); Kouji Kishida, Tokyo (JP); Naoki Sawada, Tokyo (JP); Nobuaki Matoba, Hyogo (JP)

(73) Assignee: Caterpillar SARL, Geneva (CH)

(21) Appl. No.: 15/032,005

(22) PCT Filed: Nov. 4, 2014
(86) PCT No.: PCT/EP2014/073739

§ 371 Date: Apr. 25, 2016

(30) Foreign Application Priority Data
Nov. 6, 2013 (JP) 2013-230535

(51) Int. Cl. E02F 9/22; E02F 3/32; F15B 11/08; F15B 13/04; F15B 1/04; F15B 1/02

(52) U.S. Cl. CPC E02F 9/2217; F15B 1/04; F15B 1/024; F15B 11/08; F15B 13/0401; E02F 9/2267; E02F 9/2296; E02F 3/32; E02F 9/2292; F15B 2201/405; F15B 2201/411; F15B 2211/50; E02F 9/2285

(57) ABSTRACT

Provided is a hydraulic circuit capable of efficiently recovering one and the other hydraulic energies for utilization by separating and recovering the same, one hydraulic energy being extruded from a hydraulic cylinder and the other hydraulic energy being extruded in starting and stopping rotation of a hydraulic motor, so as to allow an energy density of an accumulator to increase. The hydraulic circuit has: a first accumulator that accumulates pressure of hydraulic oil extruded from a boom cylinder; and a second accumulator that accumulates one pressure of the hydraulic oil relieved when the rotation of a swing motor is started and another pressure of the hydraulic oil extruded from a motor driving circuit with inertial rotation of the swing motor when rotation of the swing motor is stopped. A solenoid switch valve in passages that connect the first second accumulators closes the passages when pressure is accumulated in the second accumulator opens when the pressure in the second accumulator is discharged.

### TECHNICAL FIELD

The present invention relates to a hydraulic pressure circuit having an accumulator and a working machine on which the hydraulic pressure circuit is mounted.

### BACKGROUND ART

In a working machine, pressurized oil discharged from a boom hydraulic cylinder during a boom lowering operation is accumulated in an accumulator and pressurized oil relieved from a swinging hydraulic motor during acceleration or deceleration of the swinging is also accumulated in the accumulator (for example, see Patent Literature 1).

Patent Literature 1: Japanese Patent Application Publication No. 2010-84888

When pressurized oil discharged from a boom hydraulic cylinder is accumulated in an accumulator, the relief pressure of the accumulator is set to be high in order to increase energy density in the accumulator as high as possible. On the other hand, since the relief pressure of a swinging hydraulic motor is set to be lower than the system pressure of other actuators, pressure equal to or higher than the relief pressure for securing accelerating performance and braking performance when stopping the swinging cannot be accumulated in the accumulator. Thus, the upper limit pressure of the accumulator is set to be lower than the relief pressure.

Thus, when the pressurized oil from the boom hydraulic cylinder and the pressurized oil from the swinging hydraulic motor are accumulated in one accumulator, the relief pressure of the accumulator is determined by the lower relief pressure of the swinging hydraulic motor. Therefore, it is difficult to increase the energy density of the accumulator. Due to this, the accumulator and the pump motor have to be enlarged, and the cost increases.

### DISCLOSURE OF THE INVENTION

The present invention has been made in view of such a problem, and an object thereof is to provide a hydraulic pressure circuit and a working machine capable of separating hydraulic pressure energy pushed from a hydraulic pressure cylinder and hydraulic pressure energy pushed when a hydraulic pressure motor starts or stops rotating to recover respective hydraulic pressure energies to thereby recover and use the respective hydraulic pressure energies efficiently.

An invention according to claim 1 is a hydraulic pressure circuit including: a hydraulic pressure cylinder; a first accumulator that accumulates operating fluid pushed from the hydraulic pressure cylinder; a hydraulic pressure motor that operates independently from the hydraulic pressure cylinder; a motor driving circuit that supplies the operating fluid to the hydraulic pressure motor to rotate the hydraulic pressure motor and blocks the supply of the operating fluid to stop the rotation of the hydraulic pressure motor; a second accumulator that accumulates the operating fluid relieved from the motor driving circuit when the hydraulic pressure motor starts rotating and the operating fluid pushed from the motor driving circuit by rotational inertia of the hydraulic pressure motor when the hydraulic pressure motor stops rotating; a passage that connects the first and second accumulators so as to communicate with each other; and a switching valve that is provided in the passage so as to close the passage when the second accumulator accumulates the operating fluid and open the passage when the operating fluid is relieved.

An invention according to claim 2 is the hydraulic pressure circuit according to claim 1, in which the hydraulic pressure circuit further includes a sequence valve provided between the second accumulator and the motor driving circuit of the hydraulic pressure motor.

An invention according to claim 3 is the hydraulic pressure circuit according to claim 1 or 2, in which the hydraulic pressure circuit further includes: a makeup passage that makes up for the operating fluid to the motor driving circuit of the hydraulic pressure motor; and a pump that pressurizes the operating fluid and supplies the operating fluid to the makeup passage.

An invention according to claim 4 is the hydraulic pressure circuit according to claim 3, in which the pump has a displacement control function of supplying an amount of operating fluid corresponding to an acceleration or deceleration of the hydraulic pressure motor to the makeup passage.

An invention according to claim 5 is the hydraulic pressure circuit according to claim 3 or 4, in which the pump is an assist pump motor having a motor function of assisting an engine that drives the pump, the first accumulator and the second accumulator have a function of discharging the accumulated operating fluid to the assist pump motor during the assisting, and the switching valve has a function of closing the passage when the engine assist discharging is not performed and also when the pressure of the first accumulator is lower than the pressure of the second accumulator, and moreover have a function of opening the passage when the engine assist discharging is performed.

An invention according to claim 6 is a working machine including: a lower traveling body; an upper swinging body provided so as to be swingable relative to the lower traveling body by a hydraulic pressure motor; a working unit mounted on the upper swinging body and operated to move up and down by a hydraulic pressure cylinder; and the hydraulic pressure circuit according to any one of claims 1 to 5, provided in the hydraulic pressure cylinder and the hydraulic pressure motor.

According to the invention disclosed in claim 1, the first accumulator that accumulates the operating fluid pushed from the hydraulic pressure cylinder and the second accumulator that accumulates the operating fluid relieved from the motor driving circuit when the hydraulic pressure motor starts rotating and the operating fluid pushed from the motor driving circuit by the rotational inertia of the hydraulic pressure motor when the hydraulic pressure motor stops rotating are communicated by the passage. The switching valve is provided in the middle of the passage so that the passage is closed by the switching valve when the operating fluid is accumulated in the second accumulator and the passage is opened by the switching valve when the operating fluid is discharged. When the operating fluid is accumulated, the first and second accumulators are separated by the switching valve so as to recover the respective hydraulic pressure energies. Thus, it is possible to recover the energy efficiently to a state appropriate for the respective accumulators. Moreover, it is possible to sufficiently improve the energy densities of the respective accumulators according to the respective setting pressure levels. When the operating fluid is discharged, the accumulated pressure energy can be used by both the first and second accumulators which serve as a large-capacity accumulator. Thus, it is possible to reduce the size of the accumulator and the cost.

According to the invention disclosed in claim 2, a pressure increase on the motor driving circuit side can be prevented by the sequence valve. Thus, it is possible to smoothly perform accumulation of energy in the second accumulator and the operation of stopping the hydraulic pressure motor.

According to the invention disclosed in claim 3, by pushing the operating fluid from the pump to the makeup passage connected to the motor driving circuit, it is possible to prevent the occurrence of vacuum on the hydraulic pressure motor side and to prevent a breakdown of the motor induced by vacuum.

According to the invention disclosed in claim 4, an amount of operating fluid corresponding to an acceleration or deceleration of the hydraulic pressure motor is supplied to the makeup passage from the pump having the displacement control function. Thus, it is possible to supply an appropriate amount of operating fluid required for preventing the occurrence of vacuum to the makeup passage and to reduce unnecessary energy loss.

According to the invention disclosed in claim 5, when the assist discharging is not performed and the pressure of the first accumulator is lower than the pressure of the second accumulator, the passage between both accumulators is closed by the switching valve. Thus, it is possible to sufficiently increase the energy densities of the respective accumulators according to the respective setting pressure levels. Moreover, when the assist discharging is performed, since the passage is opened by the switching valve, it is possible to supply a sufficient amount of operating fluid to the assist pump motor from a large-capacity accumulator in which the first and second accumulators are combined to assist-drive the motor. Thus, it is possible to realize an assist accumulation circuit with a combination of small and inexpensive accumulators.

According to the invention disclosed in claim 6, the upper swinging body is swung in relation to the lower traveling body by the hydraulic pressure motor, and the accumulation of energy in the second accumulator and the discharging of energy from the second accumulator to the first accumulator when the swinging accelerates or decelerates can be controlled appropriately by the switching valve. Thus, it is possible to recover the potential energy of the working unit up to a high pressure level by the first accumulator. Moreover, it is possible to improve the energy recovery efficiency when the second accumulator recovers the swing energy of the upper swinging body.

### BRIEF DESCRIPTION OF DRAWINGS

FIG. 1 is a circuit diagram illustrating an embodiment of a hydraulic pressure circuit according to the present invention;

FIG. 2 is a circuit diagram illustrating a switching state of the hydraulic pressure circuit;

FIG. 3 is a circuit diagram illustrating another switching state of the hydraulic pressure circuit; and

FIG. 4 is a perspective view illustrating an embodiment of a working machine according to the present invention.

### BEST MODE FOR CARRYING OUT THE INVENTION

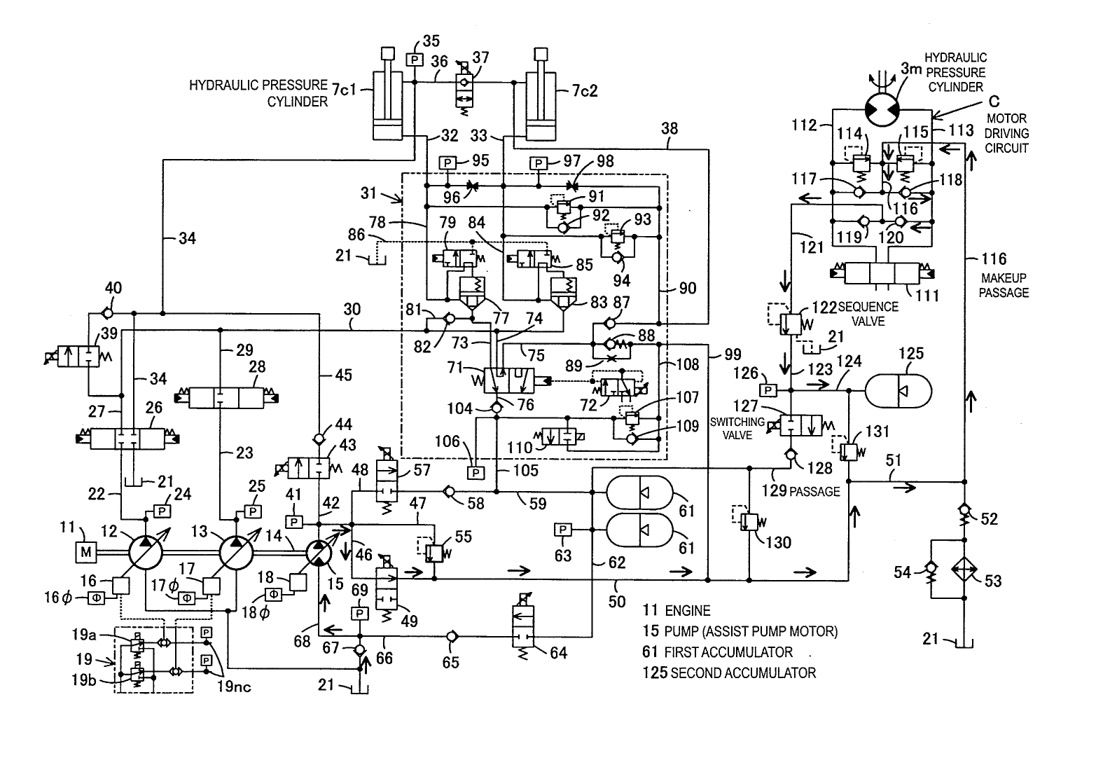

Hereinafter, the present invention will be described in detail according to an embodiment illustrated in FIGS. 1 to 4.

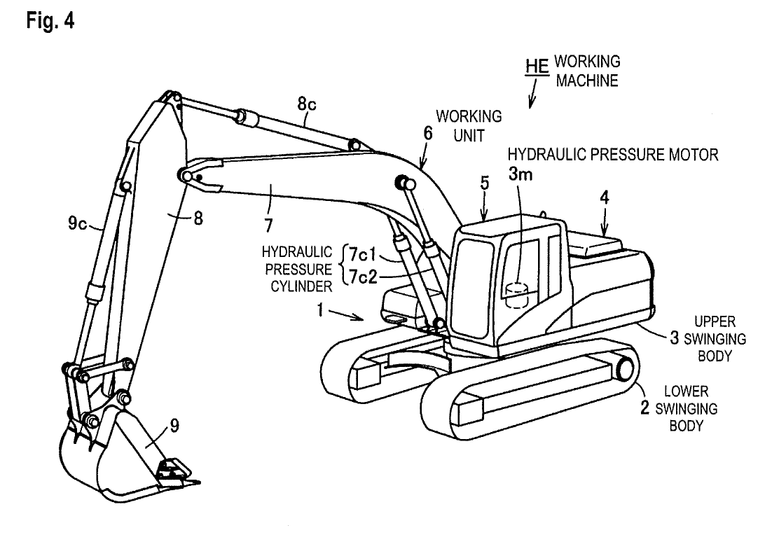

As illustrated in FIG. 4, a vehicle body 1 of an excavator HE as a working machine includes a lower traveling body 2 and an upper swinging body 3 provided on the lower traveling body 2 so as to be swingable by a swinging motor 3m as a hydraulic pressure motor. A machine chamber 4 in which an engine, a pump, and the like are mounted, a cab 5 for protecting an operator, and a working unit 6 are mounted on the upper swinging body 3.

The working unit 6 has a configuration in which a base end of a boom 7 rotated in an up-down direction by two boom cylinders 7c1 and 7c2 as hydraulic pressure cylinders arranged in parallel is supported by the upper swinging body 3, a stick 8 rotated in a front-rear direction by a stick cylinder 8c is supported by a distal end of the boom 7, and a bucket 9 rotated by a bucket cylinder 9c is supported by a distal end of the stick 8. The boom cylinders 7c1 and 7c2 are arranged in parallel in relation to the same boom 7 and perform the same operation simultaneously.

FIGS. 1 to 3 illustrate an engine power assist system which accumulates the potential energy of the working unit 6 in an accumulator with the aid of the boom cylinder 7c1 and accumulates the kinetic energy of the upper swinging body 3 in the accumulator with the aid of the swinging motor 3m to use the energy in assisting the engine power.

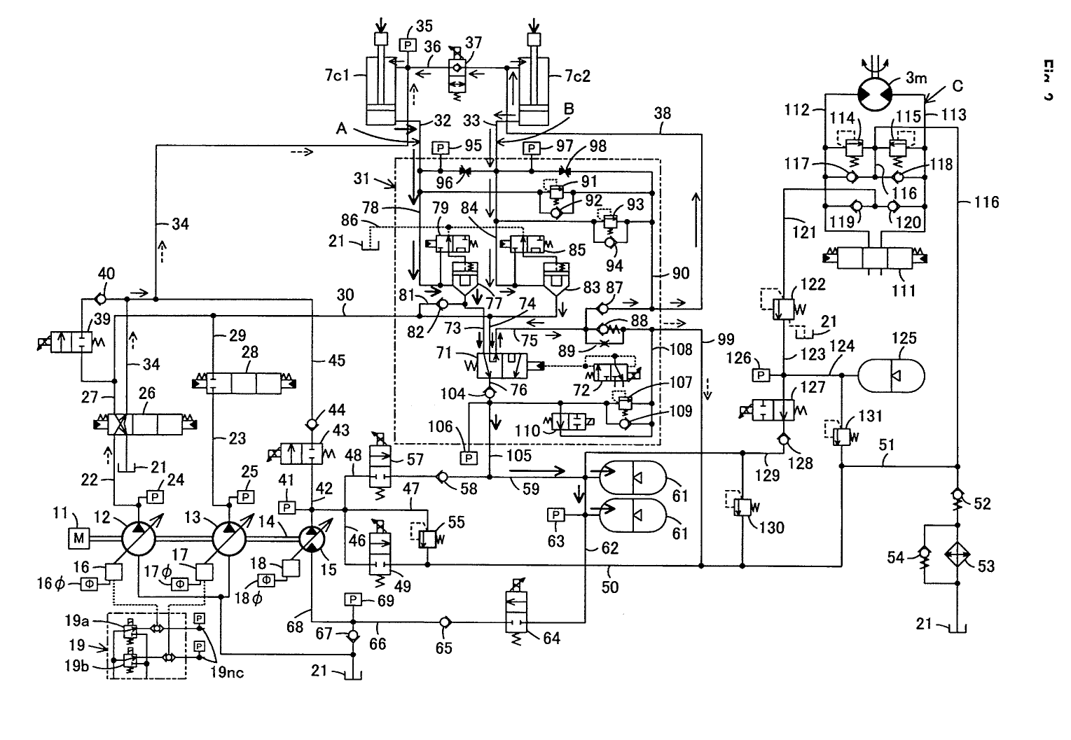

Next, a circuit configuration of this system will be described mainly based on FIG. 2.

An assist pump motor 15 that serves as a pump having a motor function and assists an engine 11 is connected directly or via gears to a main pump shaft 14 of main pumps 12 and 13 driven by the engine 11 mounted in the machine chamber 4. The main pumps 12 and 13 and the assist pump motor 15 have a swash plate capable of variably adjusting a pump/motor displacement (piston stroke) by adjusting the swash angle (tilt angle). The swash angles (tilt angles) are controlled by regulators 16, 17 and 18 and are detected by swash angle sensors 16φ, 17φ, and 18φ, and the regulators 16, 17, and 18 are controlled by electromagnetic valves. For example, the regulators 16 and 17 of the main pumps 12 and 13 can be controlled automatically by negative flow control pressure (so-called negative control pressure) guided by a negative flow control passage 19nc and can be controlled with signals other than the negative control pressure by electromagnetic switching valves 19a and 19b of a negative flow control valve 19.

The main pumps 12 and 13 discharge operating oil as operating fluid sucked up from a tank 21 to passages 22 and 23, and the pump discharge pressures thereof are detected by pressure sensors 24 and 25. An output passage 27 drawn from one side of a main boom control valve 26 for controlling the boom cylinders 7c1 and 7c2 and an output passage 29 drawn from a sub-boom control valve 28 among pilot-operated direction/flow rate control valves connected to the main pumps 12 and 13 are connected to a boom energy recovery valve 31 as a composite valve by a passage 30.

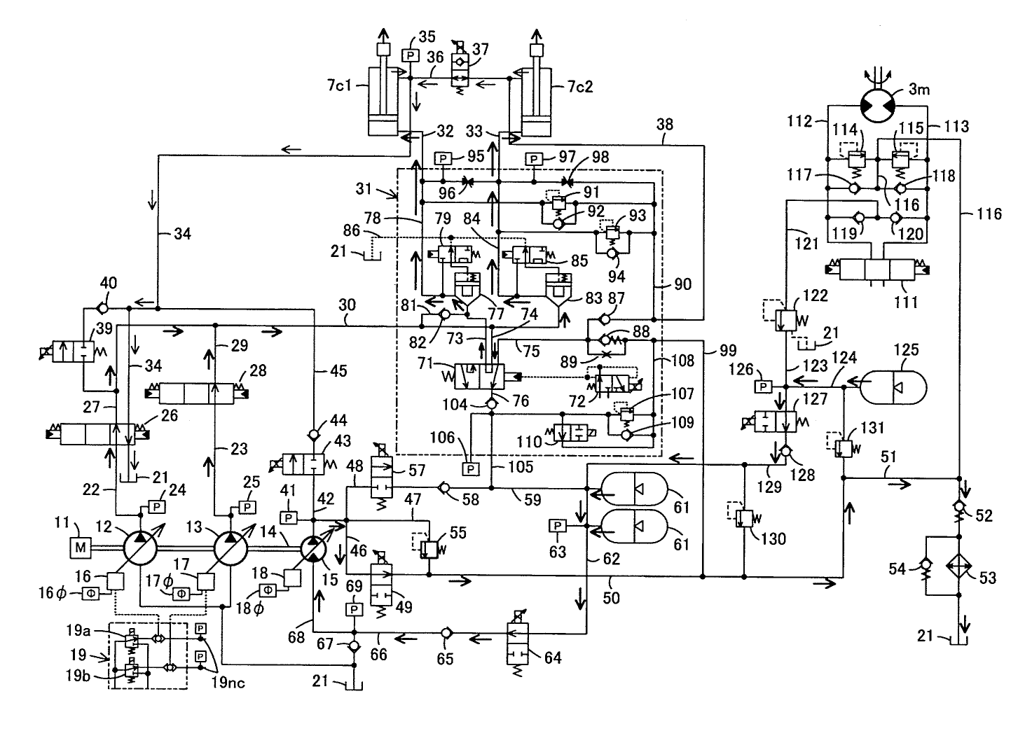

The boom energy recovery valve 31 is a composite valve in which the functions of a plurality of circuits switching an accumulation circuit A and a regeneration circuit B illustrated in FIG. 2 and a circuit illustrated in FIG. 3 for guiding the pressurized operating oil supplied from the main pumps 12 and 13 during a boom raising operation toward the head side of the two boom cylinders 7c1 and 7c2 are incorporated into a single block.

The head-side ends of the two boom cylinder 7c1 and 7c2 are connected to the boom energy recovery valve 31 by passages 32 and 33, respectively. The other output passage 34 drawn from the main boom control valve 26 is connected to one of the boom cylinders—the boom cylinder 7c1, and a pressure sensor 35 that detects a rod-side pressure of the boom cylinder is provided in the rod-side end. The rod-side ends of the two boom cylinders 7c1 and 7c2 arranged in parallel can communicate with each other with the aid of a bypass passage 36, and the communication between the rod-side ends of the boom cylinders 7c1 and 7c2 can be blocked by an electromagnetic separation valve 37 provided in the middle of the bypass passage 36. The rod-side end of the boom cylinder 7c2 is connected to the boom energy recovery valve 31 by a passage 38.

The output passage 27 drawn from the one side of the main boom control valve 26 can communicate with the other output passage 34 via an electromagnetic switching valve 39 and a check valve 40. Moreover, a pressure sensor 41 is provided on the discharge side of the assist pump motor 15 so as to detect the discharge pressure of the assist pump motor 15, an electromagnetic switching valve 43 is provided in the discharge passage 42, and a passage 45 that passes through a check valve 44 is connected to the output passage 34.

The discharge passage 42 of the assist pump motor 15 branches into three passages 46, 47, and 48. The passage 46 is connected to an electromagnetic unload valve 49, and the connection of the electromagnetic unload valve 49 extends from tank passages 50 and 51 to a spring check valve 52 and then to the tank 21 via and an oil cooler 53 or a spring check valve 54. The passage 47 is connected to a tank passage 50 via a relief valve 55.

The passage 48 is connected to an accumulator passage 62 in which a plurality of first accumulators 61 are provided via an electromagnetic switching valve 57, a check valve 58, and a passage 59, and a pressure sensor 63 that detects pressure accumulated in the first accumulator 61 is connected to the accumulator passage 62. The accumulator passage 62 is connected to a passage 66 via an electromagnetic regeneration valve 64 and a check valve 65. The passage 66 extends from the tank 21 and is connected to an intake-side passage 68 connected to an intake port of the assist pump motor 15 via a check valve 67. A pressure sensor 69 that detects an intake-side pressure of the assist pump motor is provided in the intake-side passage 68.

The assist pump motor 15 has a function of switching the electromagnetic regeneration valve 64 to a communicating position when accumulation in the first accumulator 61 progresses and the accumulator pressure has increased to a predetermined value to suck in the operating oil from the first accumulator 61 to thereby prevent an increase in the pressure of the accumulator 61 and pressurize the sucked operating oil and supply the same to the rod side of the boom cylinder 7c1.

The boom energy recovery valve 31 includes a pilot-operated main switching valve 71. The main switching valve 71 controls supply of pilot pressure with the aid of an electromagnetic switching valve 72 to thereby switch the relation between the passages 73, 74, 75, and 76.

The passage 73 is connected to one port of one of drift reduction valves—a drift reduction valve 77—and an external passage 32 drawn from the head-side end of the boom cylinder 7c1 is connected to the other port of the drift reduction valve 77 via a passage 78. The drift reduction valve 77 controls opening/closing and an opening degree of ports by controlling pilot pressure in a spring chamber with the aid of a pilot valve 79. A passage 81 branched from the passage 30 is connected to the passage 73 via a check valve 82.

The passage 74 is connected to the passage 30 and is also connected to one port of the other one of the drift reduction valves—a drift reduction valve 83. An external passage 33 drawn from the head-side end of the other boom cylinder 7c2 is connected to the other port of the drift reduction valve 83 via an inner passage 84. The drift reduction valve 83 controls opening/closing and an opening degree of ports by controlling a pilot pressure in spring chamber with the aid of a pilot valve 85.

The pilot valves 79 and 85 allow the spring chambers of the drift reduction valves 77 and 83 to communicate with the passages 78 and 84 or a passage 86 to the tank 21.

The passage 75 branches into a check valve 87, a spring check valve 88, and a passage to a variable throttle valve 89. A passage that passes through the check valve 87 is connected to an external passage 38 and an inner passage 90. A relief valve 91 and a check valve 92 are provided between the passage 90 and the passage 78, and a relief valve 93 and a check valve 94 are provided between the passage 90 and the passage 84. Further, a pressure sensor 95 and an adjustment valve 96 are provided between the passage 78 and the passage 84, and a pressure sensor 97 and an adjustment valve 98 are provided between the passage 84 and the passage 90. The spring check valve 88 and the variable throttle valve 89 are connected to the tank passage 50 via a passage 99.

The passage 76 is connected to the passage 59 via a passage 105 that passes through a check valve 104, and the pressure of the passage 105 is detected by a pressure sensor 106. A passage branched from the passage 105 is connected to the tank passage 50 via a relief valve 107, a passage 108, and the passage 99. The passage 108 communicates with the passage 105 via the check valve 109, and the passage 105 is connected to the passage 108 via an electromagnetic switching valve 110.

As illustrated in FIG. 2, the accumulation circuit A is a circuit which extends from the passage 32 drawn from the head-side end of one of the boom cylinders—the boom cylinder 7c1—and reaches the first accumulator 61 via the passage 78, the drift reduction valve 77, the passage 73, the main switching valve 71, the check valve 104, and the passage 105 in the boom energy recovery valve 31. The accumulation circuit A has a function of accumulating the oil pushed from the head side of the boom cylinder 7c1 in the accumulator 61.

As illustrated in FIG. 2, the regeneration circuit B is a circuit which extends from the passage 33 drawn from the head-side end of the other boom cylinder 7c2 and reaches the rod-side end of the other boom cylinder 7c2 via the passage 84, the drift reduction valve 83, the passage 74, the main switching valve 71, the passage 75, the check valve 87, and the passage 38 in the boom energy recovery valve 31. The regeneration circuit B has a function of regenerating the oil pushed from the head side of the boom cylinder 7c2 and supplying the same to the rod side of the boom cylinder 7c2.

A motor driving circuit C that connects the swinging motor 3m and a swinging control valve 111 that controls the swinging direction and speed of the swinging motor 3m is a hydraulic circuit that supplies operating oil to the swinging motor 3m to rotate the swinging motor 3m and forcibly blocks the supply of operating oil to stop the rotation of the swinging motor 3m. Opposing relief valves 114 and 115 and opposing check valves 117 and 118 are provided between the passages 112 and 113 of the motor driving circuit C of the swinging motor 3m. A makeup passage 116 having a tank passage function of returning the oil discharged from the motor driving circuit C to the tank 21 and a makeup function of making up for the operating oil to the motor driving circuit C is connected between the relief valves 114 and 115 and between the check valves 117 and 118. Operating oil is replenished from the makeup passage 116 to a side where there is a possibility of the occurrence of vacuum in the passages 112 and 113 via the check valves 117 and 118 with pressure which does not exceed the spring biasing pressure of the spring check valve 52.

The makeup passage 116 can communicate with the discharge side of the assist pump motor 15 via the tank passages 51 and 50 as illustrated in FIG. 1, and the pressurized operating oil is supplied thereto from the assist pump motor 15. The assist pump motor 15 has a displacement control function of supplying an amount of operating oil corresponding to an acceleration or deceleration of the swinging motor 3m to the makeup passage 116. This displacement control function involves the regulator 18 controlling the pump swash angle (tilt angle) so that the more abrupt the change in an operation amount of a lever that pilot-operates the swinging control valve 111, the larger amount of oil supplied from the assist pump motor 15 to the makeup passage 116.

Further, the passages 112 and 113 of the motor driving circuit C communicate with a swing energy recovery passage 121 via check valves 119 and 120. The passage 121 is connected to a passage 123 via a sequence valve 122 in which source pressure on an inlet side rarely changes with back pressure on an outlet side and is also connected to a second accumulator 125 via a passage 124. The pressure associated with the second accumulator 125 is detected by a pressure sensor 126.

The sequence valve 122 is set to relieve at lower pressure than the relief valves 114 and 115 so that the relieved operating oil can be supplied from the motor driving circuit C to the second accumulator 125 via the sequence valve 122 before the relief valves 114 and 115 relieve.

That is, the second accumulator 125 converts the driving energy of the operating oil relieved from the motor driving circuit C via the sequence valve 122 when the swinging motor 3m starts rotating and the braking energy of the operating oil relieved from the motor driving circuit C via the sequence valve 122 with the rotational inertia of the swinging motor 3m when the swinging motor 3m stops swinging into pressure and accumulates the pressure.

The passage 123 is connected to the accumulator passage 62 of the first accumulator 61 by a passage 129 that passes through a check valve 128 and an electromagnetic switching valve 127 as a switching valve. The passages 123 and 129 connect the first and second accumulators 61 and 125 so as to communicate with each other and connect the passage 129 and the tank passage 50 via a relief valve 130. The second accumulator 125 is connected to the tank passage 51 via a relief valve 131.

The electromagnetic switching valve 127 provided in the middle of the passages 123 and 129 performs control of closing the passages 123 and 129 when assist discharging is not performed and the pressure of the first accumulator 61 is lower than the pressure of the second accumulator 125 and opening the passages 123 and 129 when the accumulator 125 performs assist discharging.

In the circuit configuration described above, the swash angle sensors 16φ, 17φ, and 18φ, the pressure sensors 24, 25, 35, 41, 63, 69, 95, 97, 106, and 126 input the detected swash angle signals and the pressure signals to an in-vehicle controller (not illustrated). Moreover, the electromagnetic switching valves 39, 43, 57, 72, 110, and 127, the electromagnetic unload valve 49, and the electromagnetic regeneration valve 64 are turned on and off according to a driving signal output from the in-vehicle controller (not illustrated) or switched by a proportional operation according to the driving signal. Moreover, the boom control valves 26 and 28, the swinging control valve 111, and other hydraulic actuator control valves (not illustrated) (including traveling motor, stick cylinder, and bucket cylinder control valves and the like) are pilot-operated by a manual operating valve (so-called a remote control valve) which is lever-operated or pedal-operated by an operator in the cab 5, and the pilot valves 79 and 85 of the drift reduction valves 77 and 83 are also pilot-operated in an interlinked manner.

Hereinafter, the contents of the functions controlled by the in-vehicle controller will be described.

(Engine Power Assisting Function)

An engine power assisting function of the hydraulic pressure circuit having the above-described configuration will be described.

FIG. 2 illustrates a circuit state when a boom lowering operation of lowering the boom 7 is performed. When pressurized operating oil is supplied from the main pump 12 to the rod side of one of the boom cylinders—the boom cylinder 7c1—via the boom control valve 26, the operating oil pushed from the head side of the boom cylinder 7c1 to the passages 32 and 78 is controlled so as to flow from the passage 73 to the passage 76 via the drift reduction valve 77 of the boom energy recovery valve 31 by the main switching valve 71. The operating oil is accumulated in the first accumulator 61 via the passages 105 and 59.

At the same time, the operating oil pushed from the head side of the other boom cylinder 7c2 to the passages 33 and 84 is controlled so as to flow from the passage 74 to the passage 75 via the drift reduction valve 83 of the boom energy recovery valve 31 by the main switching valve 71 and is regenerated on the rod side of the boom cylinder 7c2 via the check valve 87 and the passage 38. The operating oil is also regenerated on the rod side of the boom cylinder 7c1 via the check valve in the electromagnetic separation valve 37.

In this manner, the boom energy recovery valve 31 performs accumulation in the first accumulator 61 during the boom lowering operation and regeneration on the rod side of the boom cylinders 7c1 and 7c2 at the same time with the aid of the main switching valve 71 and the drift reduction valves 77 and 83.

FIG. 3 illustrates a circuit state when a boom raising operation of raising the boom 7 is performed. The boom energy recovery valve 31 during the boom raising operation stops the accumulation in the first accumulator 61 and the regeneration on the rod side of the boom cylinders 7c1 and 7c2, controls the operating oil supplied from the main pumps 12 and 13 to the passage 30 via the boom control valves 26 and 28 so as to flow from the passage 74 to the passage 73 with the aid of the switched main switching valve 71 in the boom energy recovery valve 31 so that the operating oil is guided from the passages 73 and 30 to the head side of the boom cylinders 7c1 and 7c2 via the drift reduction valves 77 and 83.

In this case, in order to allow the assist pump motor 15 that has a pump and motor function and is connected directly or via gears to the main pump shaft 14 to function as a hydraulic motor as illustrated in FIG. 3, the electromagnetic unload valve 49, the electromagnetic regeneration valve 64, and the electromagnetic switching valve 127 are switched to the communicating position to rotate the assist pump motor 15 with the energy accumulated in the first and second accumulators 61 and 125 to assist the hydraulic output power of the main pumps 12 and 13 to reduce an engine load.

In this manner, due to the engine power assisting function, the first accumulator 61 accumulates the head-side pressure of one of the boom cylinders—the boom cylinder 7c1—and regenerates the head-side pressure of the other boom cylinder 7c2 on the rod side of the boom cylinders 7c1 and 7c2 to allow the assist pump motor 15 to rotate as a hydraulic motor with the operating oil accumulated in the first and second accumulators 61 and 125 to thereby allow the assist pump motor 15 to reduce the load of the engine 11 connected via the main pump shaft 14.

When the engine load is small, the electromagnetic switching valve 57 is switched to the communicating position to allow the assist pump motor 15 to function as a hydraulic pump to supply the operating oil sucked up from the tank 21 to the first accumulator 61 to accumulate the operating oil in the first accumulator 61.

(Swing Energy Recovery Function)

Next, a swing energy recovery function will be described.

The sequence valve 122 is set such that the source pressure on an inlet side rarely changes with back pressure on the outlet side and the source pressure is lower than the setting pressure of the relief valves 114 and 115 whereby the driving energy before exceeding the setting pressure of the relief valves 114 and 115 when swinging is accelerated is absorbed and accumulated in the second accumulator 125 as hydraulic pressure energy, and the braking energy emitted outside from the passages 112 and 113 of the motor driving circuit C when swinging stops is absorbed and accumulated in the second accumulator 125 as hydraulic pressure energy.

That is, the sequence valve 122 in which the source pressure on the inlet side rarely changes with the back pressure on the outlet side is employed, and the operating oil leaking from the sequence valve 122 when rotation accelerates and decelerates is recovered and accumulated in the second accumulator 125.

Further, in order to reduce energy loss as much as possible, the electromagnetic switching valve 127 that opens and closes the passages 123 and 129 between the first and second accumulators 61 and 125 is provided so that the accumulator pressure is also discharged from the second accumulator 125 when the pressure discharged from the first accumulator 61 has decreased to be equal to the pressure of the second accumulator 125. That is, in order to improve energy recovery efficiency and to reduce pressure drop as much as possible, the electromagnetic switching valve 127 is provided between the first and second accumulators 61 and 125 having different pressure levels.

An operation pattern of the electromagnetic switching valve 127 is set as follows.

(a) When the control mode is not the assist mode and the accumulator pressure satisfies a relation of (first accumulator pressure)<(second accumulator pressure)<(22 MPa), the electromagnetic switching valve 127 is closed and the passages 123 and 129 are blocked to accumulate the pressurized oil in the second accumulator 125.

(b) When the accumulator satisfies a relation of (second accumulator)>22 MPa, the electromagnetic switching valve 127 is open and the pressurized oil accumulated in the second accumulator 125 is supplied to the passage 62 of the first accumulator 61 via the passages 123 and 129.

(c) When the control mode is the assist mode, the electromagnetic switching valve 127 is open so that the passages 123 and 129 communicate with each other. In this way, even when the pressure discharged from the first accumulator 61 decreases, the assist pump motor 15 is driven as a motor with the pressurized oil discharged from the second accumulator 125 to assist the hydraulic output power of the main pumps.

That is, as illustrated in FIG. 3, in the assist mode, since the electromagnetic regeneration valve 64 provided between the first accumulator 61 and the assist pump motor 15 is switched to the communicating position, the pressurized oil discharged from the second accumulator 125 passes through the electromagnetic regeneration valve 64 via the electromagnetic switching valve 127 and the passage 62 close to the first accumulator 61 to cause the assist pump motor 15 to perform motor action to assist the hydraulic output power of the main pumps 12 and 13 to thereby reduce an engine load.

According to this swing energy recovery circuit, it is possible to use the conventional hydraulic swinging motor 3m and to recover the swing energy at a low cost. Moreover, the energy recovery efficiency is improved. Further, since the same circuit as the pressure discharge circuit of the first accumulator 61 is used, it is possible to facilitate energy control and to reduce the cost.

(Swing Vacuum Prevention Function)

In order to prevent the occurrence of vacuum on the upstream side of the swinging motor 3m when swing stopping energy is supplied to the second accumulator 125, a function of supplying oil from the assist pump motor 15 is provided to the makeup passage 116.

That is, when oil is discharged from one passage of the motor driving circuit C to the second accumulator 125 when the swinging motor 3m stops swinging, vacuum occurs in the other passage of the motor driving circuit C, which can cause a breakdown of the motor. In order to prevent this, the electromagnetic unload valve 49 is open from the start point of a swinging operation as illustrated in FIG. 1 to detect an amount of arm operation and an operation speed of a swing operation lever, the swash angle of the assist pump motor 15 is controlled according to the detection values, and an amount of oil corresponding to the operation amount and the operation speed of the swing operation lever is supplied from the assist pump motor 15 to a passage in the motor driving circuit C where there is a possibility of the occurrence of vacuum via the electromagnetic unload valve 49, the tank passages, 50 and 51, and the makeup passage 116. In this way, the occurrence of swing vacuum is prevented.

Next, the advantageous effects of the embodiment will be described.

The first accumulator 61 that accumulates the operating oil pushed from the boom cylinder 7c1 and the second accumulator 125 that accumulates the operating oil relieved from the motor driving circuit C via the sequence valve 122 when the swinging motor 3m starts rotating and the operating oil pushed from the motor driving circuit C by the rotational inertia of the swinging motor 3m when the swinging motor 3m stops rotating are communicated by the passages 123 and 129. The electromagnetic switching valve 127 is provided in the middle of the passages 123 and 129 so that the passages 123 and 129 are closed by the electromagnetic switching valve 127 when the operating fluid is accumulated in the second accumulator 125 and the passages 123 and 129 are opened by the electromagnetic switching valve 127 when the operating fluid is discharged. When the operating fluid is accumulated, the first and second accumulators 61 and 125 are separated by the electromagnetic switching valve 127 so as to recover the respective hydraulic pressure energies. Thus, it is possible to recover the energy efficiently to a state appropriate for the respective, accumulators 61 and 125. Moreover, it is possible to sufficiently improve the energy densities of the respective accumulators 61 and 125 according to the respective setting pressure levels. When the operating fluid is discharged, the accumulated pressure energy can be used by both the first and second accumulators 61 and 125 which serve as a large-capacity accumulator. Thus, it is possible to reduce the size of the accumulator and the cost.

In particular, when the assist discharging is not performed and the pressure of the first accumulator 61 is lower than the pressure of the second accumulator 125, the passages 123 and 129 between both accumulators 61 and 125 are closed by the electromagnetic switching valve 127. Thus, it is possible to sufficiently increase the energy densities of the respective accumulators 61 and 125 according to the respective setting pressure levels. Moreover, when the assist discharging is performed, since the passages 123 and 129 are opened by the electromagnetic switching valve 127, it is possible to supply a sufficient amount of operating fluid to the assist pump motor 15 from a large-capacity accumulator in which the first and second accumulators 61 and 125 are combined to assist-drive the motor 15. Thus, it is possible to realize an assist accumulation circuit with a combination of small and inexpensive accumulators 61 and 125.

A pressure increase on the motor driving circuit C side can be prevented by the sequence valve 122 in which the source pressure on the inlet side rarely changes with the back pressure on the outlet side. Thus, it is possible to smoothly perform accumulation of energy in the second accumulator 125 and the operation of stopping the swinging motor 3m.

By pushing the operating oil from the assist pump motor 15 to the makeup passage 116 connected to the motor driving circuit C, it is possible to prevent the occurrence of vacuum on the motor driving circuit C side of the swinging motor 3m and to prevent a breakdown of the motor induced by vacuum.

The operation amount and the operation speed of the swing operation lever are detected and an amount of operating fluid corresponding to the detection values is supplied to the makeup passage 116 from the assist pump motor 15 having the displacement control function. Thus, it is possible to supply an appropriate amount of oil required for preventing the occurrence of vacuum to the motor driving circuit C of the swinging motor 3m through the makeup passage 116 and to reduce unnecessary energy loss.

The upper swinging body 3 is swung in relation to the lower traveling body 2 by the swinging motor 3m, and the accumulation of energy in the second accumulator 125 and the discharging of energy from the second accumulator 125 to the first accumulator 61 when the swinging accelerates or decelerates can be controlled appropriately by the electromagnetic switching valve 127. Thus, it is possible to recover the potential energy of the working unit 6 up to a high pressure level by the first accumulator 61. Moreover, it is possible to improve the energy recovery efficiency when the second accumulator 125 recovers the swing energy of the upper swinging body 3.

### INDUSTRIAL APPLICABILITY

The present invention is industrially applicable to business operators associated with manufacturing and selling hydraulic pressure circuits or working machines.

### EXPLANATION OF REFERENCE NUMERALS

HE: Excavator as working machine
2: Lower traveling body
3: Upper swinging body
3m: Swinging motor as hydraulic pressure motor
C: Motor driving circuit
6: Working unit
7c1: Boom cylinder as hydraulic pressure cylinder
11: Engine
15: Assist pump motor as pump
61: First accumulator
116: Makeup passage
122: Sequence valve
125: Second accumulator
127: Electromagnetic switching valve as switching valve
129: Passage

1. A hydraulic pressure circuit comprising:
a hydraulic pressure cylinder;
a first accumulator that accumulates operating fluid pushed from the hydraulic pressure cylinder;
a hydraulic pressure motor that operates independently from the hydraulic pressure cylinder;
a motor driving circuit that supplies the operating fluid to the hydraulic pressure motor to rotate the hydraulic pressure motor and blocks the supply of the operating fluid to stop the rotation of the hydraulic pressure motor;
a second accumulator that accumulates the operating fluid relieved from the motor driving circuit when the hydraulic pressure motor starts rotating and the operating fluid pushed from the motor driving circuit by rotational inertia of the hydraulic pressure motor when the hydraulic pressure motor stops rotating;
a passage that connects the first and second accumulators so as to communicate with each other; and
a switching valve that is provided in the passage so as to close the passage when the second accumulator accumulates the operating fluid and open the passage when the operating fluid is relieved.

2. The hydraulic pressure circuit according to claim 1, further comprising:
a sequence valve provided between the second accumulator and the motor driving circuit of the hydraulic pressure motor.

3. The hydraulic pressure circuit according to claim 1, further comprising:
a makeup passage that makes up for the operating fluid to the motor driving circuit of the hydraulic pressure motor; and
a pump that pressurizes the operating fluid and supplies the operating fluid to the makeup passage.

4. The hydraulic pressure circuit according to claim 3, wherein
the pump has a displacement control function of supplying an amount of operating fluid corresponding to at least one of an acceleration and a deceleration of the hydraulic pressure motor to the makeup passage.

5. The hydraulic pressure circuit according to claim 3, wherein
the pump is an assist pump motor having a motor function of assisting an engine that drives the pump,
the first accumulator and the second accumulator have a function of discharging the accumulated operating fluid to the assist pump motor during the assisting, and
the switching valve has a function of closing the passage when the engine assist discharging is not performed and also when the pressure of the first accumulator is lower than the pressure of the second accumulator, and moreover have a function of opening the passage when the engine assist discharging is performed.

6. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 1, provided in the hydraulic pressure cylinder and the hydraulic pressure motor.

7. The hydraulic pressure circuit according to claim 2, further comprising:
a makeup passage that makes up for the operating fluid to the motor driving circuit of the hydraulic pressure motor; and
a pump that pressurizes the operating fluid and supplies the operating fluid to the makeup passage.

8. The hydraulic pressure circuit according to claim 7, wherein
the pump has a displacement control function of supplying an amount of operating fluid corresponding to at least one of an acceleration and a deceleration of the hydraulic pressure motor to the makeup passage.

9. The hydraulic pressure circuit according to claim 8, wherein
the pump is an assist pump motor having a motor function of assisting an engine that drives the pump,
the first accumulator and the second accumulator have a function of discharging the accumulated operating fluid to the assist pump motor during the assisting, and
the switching valve has a function of closing the passage when the engine assist discharging is not performed and also when the pressure of the first accumulator is lower than the pressure of the second accumulator, and moreover have a function of opening the passage when the engine assist discharging is performed.

10. The hydraulic pressure circuit according to claim 7, wherein
the pump is an assist pump motor having a motor function of assisting an engine that drives the pump,
the first accumulator and the second accumulator have a function of discharging the accumulated operating fluid to the assist pump motor during the assisting, and
the switching valve has a function of closing the passage when the engine assist discharging is not performed and also when the pressure of the first accumulator is lower than the pressure of the second accumulator, and moreover have a function of opening the passage when the engine assist discharging is performed.

11. The hydraulic pressure circuit according to claim 4, wherein
the pump is an assist pump motor having a motor function of assisting an engine that drives the pump,
the first accumulator and the second accumulator have a function of discharging the accumulated operating fluid to the assist pump motor during the assisting, and
the switching valve has a function of closing the passage when the engine assist discharging is not performed and also when the pressure of the first accumulator is lower than the pressure of the second accumulator, and moreover have a function of opening the passage when the engine assist discharging is performed.

12. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 2, provided in the hydraulic pressure cylinder and the hydraulic pressure motor.

13. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 3, provided in the hydraulic pressure cylinder and the hydraulic pressure motor.

14. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 4, provided in the hydraulic pressure cylinder and the hydraulic pressure motor.

15. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 5, provided in the hydraulic pressure cylinder and the hydraulic pressure motor.

16. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 7, provided in the hydraulic pressure cylinder and the hydraulic pressure motor.

17. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 8, provided in the hydraulic pressure cylinder and the hydraulic pressure motor.

18. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 9, provided in the hydraulic pressure cylinder and the hydraulic pressure motor.

19. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 10, provided in the hydraulic pressure cylinder and the hydraulic pressure motor.

20. A working machine comprising:
a lower traveling body;
an upper swinging body provided so as to be rotatable relative to the lower traveling body by a hydraulic pressure motor;
a working unit mounted on the upper swinging body and operated to move up and down by a hydraulic pressure cylinder; and
the hydraulic pressure circuit according to claim 11, provided in the hydraulic pressure cylinder and the hydraulic pressure motor.
